(19) United States
(12) Patent Application Publication
(10) Pub. No.: US 2017/0324447 A1
(43) Pub. Date: Nov. 9, 2017

(54) WIRELESS POWER TRANSMITTING DEVICE AND METHOD

(71) Applicant: LG INNOTEK CO., LTD., Seoul (KR)

(72) Inventor: Jay PARK, Seoul (KR)

(73) Assignee: LG INNOTEK CO., LTD., Seoul (KR)

(21) Appl. No.: 15/524,768

(22) PCT Filed: Nov. 5, 2015
(86) PCT No.: PCT/KR2015/011859

§ 371 Date: May 5, 2017

(30) Foreign Application Priority Data
Nov. 6, 2014 (KR) 10-2014-0153593
Nov. 2, 2015 (KR) 10-2015-0153357

(51) Int. Cl. H04B 5/00; H02J 50/05; H02J 50/12; H02J 7/02

(52) U.S. Cl. CPC H04B 5/0037; H02J 7/025; H02J 50/05; H02J 50/12

(57) ABSTRACT

The present invention relates to a wireless power transmitting device and method which are configured to: transmit a first state confirmation signal through a first transmitting method; transmit power through the first transmitting method when a first state response signal corresponding to the first state confirmation signal is received; and transmit a second state confirmation signal through a second transmitting method when the first state response signal is not received. According to the present invention, the wireless power transmitting device alternatingly uses the first transmitting method and the second transmitting method, and the existence of a wireless power receiving device and a receiving method thereof can be detected.

### TECHNICAL FIELD

The present invention relates to a wireless power charging system, and more particularly, to a wireless power transmitting device and method in a wireless power charging system.

### BACKGROUND ART

Generally, various electronic devices include a battery and are driven by using power charged in the battery. In this case, in the electronic device, the battery may be replaced and charged again. To this end, the electronic device includes a contact terminal for coming in contact with an external charging device. That is, the electronic device is electrically connected to the charging device through the contact terminal. However, the contact terminal of the electronic device is exposed to the outside, and thus the contact terminal may be contaminated by foreign matter or short-circuited by moisture. In this case, there is a problem in that a contact failure occurs between the contact terminal and the charging device and the battery in the electronic device is not charged.

In order to address the above problem, a wireless power charging system for charging an electronic device in a wireless manner has been proposed. The wireless power charging system includes a wireless power transmitting device and a wireless power receiving device. The wireless power transmitting device transmits power in a wireless manner, and the wireless power receiving device receives power in a wireless manner. Here, an electronic device may include a wireless power receiving device or may be electrically connected to the wireless power receiving device. There are various charging methods in the wireless power charging system. In this case, in order to transmit power from the wireless power transmitting device to the wireless power receiving device, a charging method of the wireless power transmitting device should be the same as a charging method of the wireless power receiving device.

### DISCLOSURE

### Technical Problem

The present invention is directed to providing a wireless power transmitting device and method for efficiently transmitting power. Also, the present invention is directed to providing a wireless power transmitting device and method for transmitting power according to a plurality of charging methods.

### Technical Solution

One aspect of the present invention provides a wireless power transmitting method including transmitting a first state confirmation signal through a first transmitting method and transmitting power through the first transmitting method when a first state response signal corresponding to the first state confirmation signal is received.

The wireless power transmitting method may further include transmitting a second state confirmation signal through a second transmitting method when the first state response signal is not received.

The wireless power transmitting method may further include transmitting power through the second transmitting method when a second state response signal corresponding to the second state confirmation signal is received.

The wireless power transmitting method may return to the transmitting of the first state confirmation signal when the second state response signal is not received.

Another aspect of the present invention provides a wireless power transmitting device including a first coil for a first transmitting method, a second coil for a second transmitting method, and a controller configured to transmit a first state confirmation signal through the first coil and transmit power through the first coil when a first state response signal corresponding to the first state confirmation signal is received.

The controller may transmit a second state confirmation signal through the second coil when the first state response signal is not received.

The controller may transmit power through the second coil when a second state response signal corresponding to the second state confirmation signal is received.

The controller may transmit the first state confirmation signal through the first coil when the second state response signal is not received.

### ADVANTAGEOUS EFFECTS

In a wireless power transmitting device and method according to the present invention, the existence of a wireless power receiving device and a receiving method thereof can be detected by alternately using a first transmitting method and a second transmitting method. Thus, the wireless power transmitting device may effectively charge the wireless power receiving device using the first transmitting method and the second transmitting method. That is, the wireless power transmitting device may transmit power according to a plurality of transmitting methods. Accordingly, the wireless power transmitting device may efficiently transmit the power according to the receiving method of the wireless power receiving device.

### DESCRIPTION OF DRAWINGS

FIG. 1 is a block diagram illustrating a wireless power charging system to which the present invention is applied.

FIGS. 2A to 2E are circuit diagrams illustrating equivalent circuits of a wireless transmitter and a wireless receiver of FIG. 1.

FIG. 3 is a block diagram illustrating a wireless power transmitting device according to an embodiment of the present invention.

FIG. 4 is a graph for describing operation characteristics of a first coil and a second coil of FIG. 3.

FIG. 5 is a flowchart illustrating a wireless power transmitting process according to an embodiment of the present invention.

FIG. 6 are diagrams for describing exemplary wireless power transmitting methods according to an embodiment of the present invention.

FIG. 7 is a flowchart illustrating a wireless power transmitting process according to another embodiment of the present invention.

FIG. 8 is a diagram for describing an exemplary wireless power transmitting method according to another embodiment of the present invention.

FIG. 9 is a flowchart illustrating a wireless power transmitting process according to still another embodiment of the present invention.

FIG. 10 is a diagram for describing an exemplary wireless power transmitting method according to still another embodiment of the present invention.

FIG. 11 is a flowchart illustrating a wireless power transmitting process according to yet another embodiment of the present invention.

FIG. 12 is a diagram for describing an exemplary wireless power transmitting method according to yet another embodiment of the present invention.

### MODES OF THE INVENTION

Hereinafter, embodiments of the present invention will be described in more detail with reference to the accompanying drawings. In this case, it should be noted that like reference numerals in the drawings denote like elements. In addition, a detailed description of known functions and configurations that may unnecessarily obscure the gist of the invention will not be repeated.

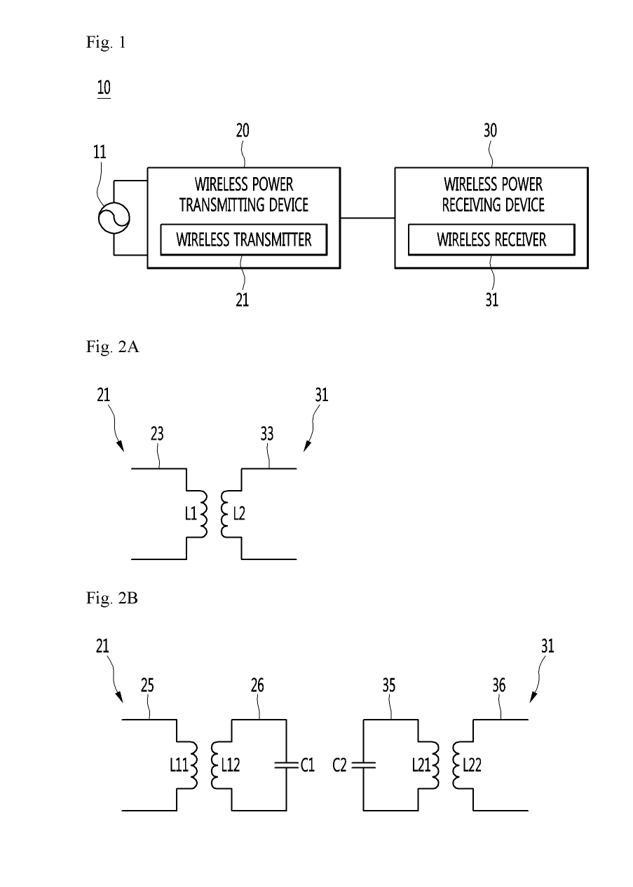

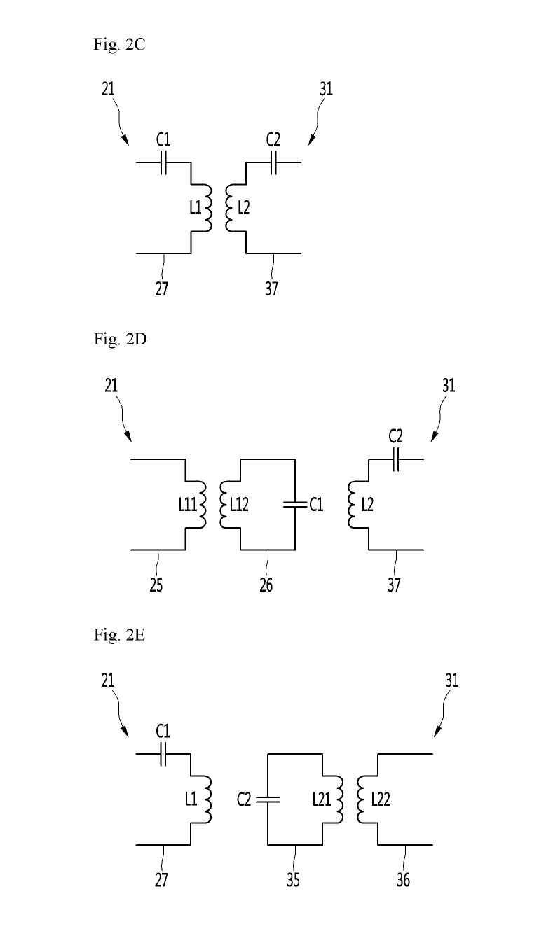

FIG. 1 is a block diagram illustrating a wireless power charging system to which the present invention is applied. FIGS. 2A to 2E are circuit diagrams illustrating equivalent circuits of a wireless transmitter and a wireless receiver of FIG. 1.

Referring to FIG. 1, a wireless power charging system 10 to which the present invention is applied includes a wireless power transmitting device 20 and a wireless power receiving device 30.

The wireless power transmitting device 20 is connected to a power source 11 to receive power from the power source 11. The wireless power transmitting device 20 transmits power in a wireless manner. Here, the wireless power transmitting device 20 may transmit alternating current (AC) power. In this case, the wireless power transmitting device 20 transmits the power according to a plurality of transmitting methods. Here, the transmitting methods include an electromagnetic induction method, a resonance method, and a radio wave/microwave radiation method. That is, at least two of the transmitting methods are preset in the wireless power transmitting device 20. Also, the wireless power transmitting device 20 may select any one of the preset transmitting methods and transmit the power using the selected method. The wireless power transmitting device 20 includes a wireless transmitter 21.

The wireless power receiving device 30 receives power in a wireless manner. Here, the wireless power receiving device 30 may receive AC power. Also, the wireless power receiving device 30 may convert AC power into direct current (DC) power. In this case, the wireless power receiving device 30 receives the power according to preset receiving methods. Here, the receiving methods include an electromagnetic induction method, a resonance method, and a radio wave/microwave radiation method. Also, the wireless power receiving device 30 may be driven using the power. The wireless power receiving device 30 includes a wireless receiver 31.

In this case, in order for the wireless power transmitting device 20 to transmit power to the wireless power receiving device 30, the wireless power receiving device 30 should be arranged to correspond to a predetermined area of the wireless power transmitting device 20. That is, the center of the wireless power transmitting device 20 should correspond to the center of the wireless power receiving device 30. Specifically, the center of the wireless power transmitting device 20 and the center of the wireless power receiving device 30 should be arranged on the same line. Also, in order for the wireless power transmitting device 20 to transmit power to the wireless power receiving device 30, any one of the transmitting methods of the wireless power transmitting device 20 should match the receiving method of the wireless power receiving device 30.

For example, when all the transmitting method of the wireless power transmitting device 20 and the receiving method of the wireless power receiving device 30 is an electromagnetic induction method, the wireless transmitter 21 and the wireless receiver 31 may be represented as illustrated in FIG. 2A. The wireless transmitter 21 may include a transmitting induction coil 23. In this case, the transmitting induction coil 23 may be represented by a transmitting inductor L1. The wireless receiver 31 may include a receiving induction coil 33. In this case, the receiving induction coil 33 may be represented by a receiving inductor L2. Accordingly, when the receiving induction coil 33 is arranged to be facing the transmitting induction coil 23, the transmitting induction coil 23 may transmit power to the receiving induction coil 33 in an electromagnetic induction method.

Meanwhile, when all the transmitting method of the wireless power transmitting device 20 and the receiving method of the wireless power receiving device 30 is a resonance method, the wireless transmitter 21 and the wireless receiver 31 may be represented as illustrated in FIGS. 2B to 2E.

The wireless transmitter 21 may include a transmitting induction coil 25 and a transmitting resonance coil 26 as illustrated in FIGS. 2B and 2D. In this case, the transmitting induction coil 25 and the transmitting resonance coil 26 may be arranged to be facing each other. The transmitting induction coil 25 may be represented by a first transmitting inductor L11. Also, the transmitting resonance coil 26 may be represented by a second transmitting inductor L12 and a transmitting capacitor C1. Here, the second transmitting inductor L12 and the transmitting capacitor C1 may be connected in series to form a closed loop. Alternatively, the wireless transmitter 21 may include a transmitting resonance coil 27 as illustrated in FIGS. 2C and 2E. In this case, the transmitting resonance coil 27 may be represented by a transmitting inductor L1 and a transmitting capacitor C1. Here, the transmitting inductor L1 and the transmitting capacitor C1 may be connected in series.

The wireless receiver 31 may include a receiving resonance coil 35 and a receiving induction coil 36 as illustrated in FIGS. 2B and 2E. In this case, the receiving resonance coil 35 and the receiving induction coil 36 may be arranged to be facing each other. Also, the receiving resonance coil 35 may be represented by a receiving capacitor C2 and a first receiving inductor L21. Here, the receiving capacitor C2 and the first receiving inductor L21 may be connected in series to form a closed loop. The receiving induction coil 36 may be represented by a second receiving inductor L22. Alternatively, the wireless receiver 31 may include a receiving resonance coil 37 as illustrated in FIGS. 2C and 2D. In this case, the receiving resonance coil 37 may be represented by a receiving inductor L2 and a receiving capacitor C2. Here, the receiving inductor L2 and the receiving capacitor C2 may be connected in series.

Accordingly, when the receiving resonance coil 35 is arranged to be facing the transmitting resonance coil 26, the transmitting resonance coil 26 may transmit power to the receiving resonance coil 35 in a resonance method. In this case, the transmitting induction coil 25 may transmit power to the transmitting resonance coil 26 in an electromagnetic induction method and the transmitting resonance coil 26 may transmit the power to the receiving resonance coil 35 in a resonance method. Alternatively, the transmitting resonance coil 26 may directly transmit power to the receiving resonance coil 35 in a resonance method. The receiving resonance coil 35 may then receive the power from the transmitting resonance coil 26 in a resonance method and the receiving induction coil 36 may receive the power from the receiving resonance coil 35 in an electromagnetic induction method. Alternatively, the receiving resonance coil 35 may receive power from the transmitting resonance coil 26 in a resonance method.

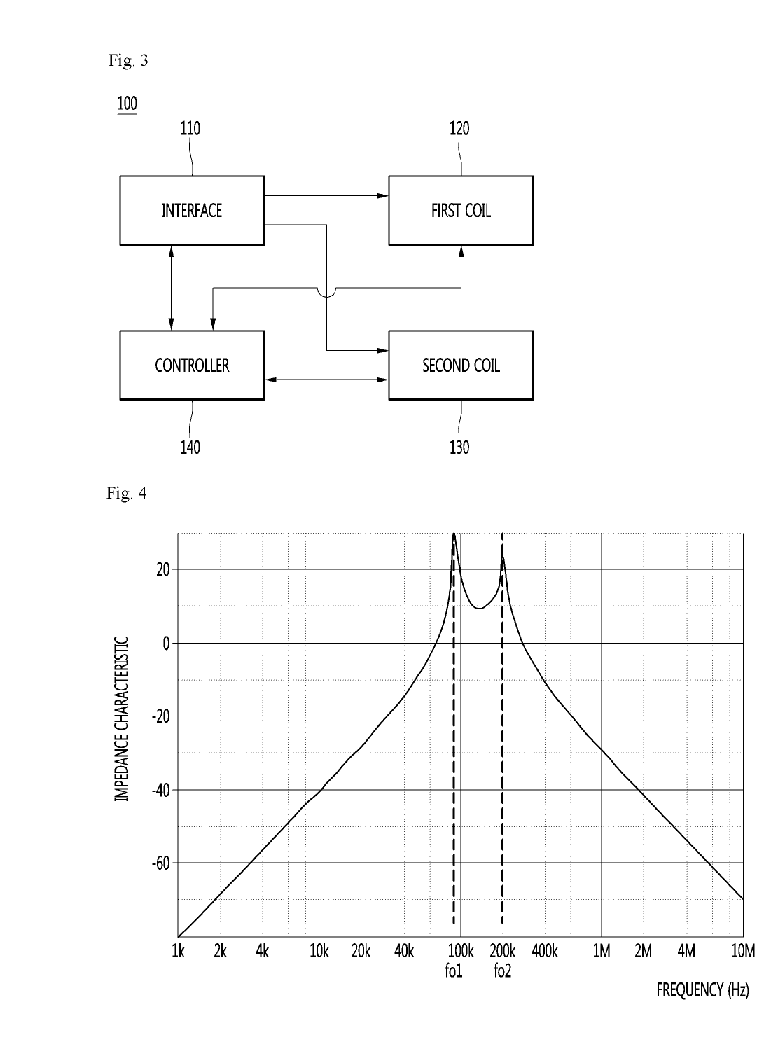

FIG. 3 is a block diagram illustrating a wireless power transmitting device according to an embodiment of the present invention. FIG. 4 is a graph for describing operation characteristics of a first coil and a second coil of FIG. 3. In this case, FIG. 4 illustrates an impedance characteristic according to a frequency in the wireless power transmitting device.

Referring to FIG. 3, a wireless power transmitting device 100 according to the present embodiment includes an interface 110, a first coil 120, a second coil 130, and a controller 140.

In the wireless power transmitting device 100, the interface 110 provides an interface with the power source 11 (see FIG. 1). That is, the interface 110 is connected to the power source 11. Here, the interface 110 may be connected to the power source 11 in a wired manner. The interface 110 receives power from the power source 11. Here, the interface 110 receives DC power from the power source 11.

In the wireless power transmitting device 100, the first coil 120 and the second coil 130 transmit power in a wireless manner. In this case, the first coil 120 and the second coil 130 transmit the power according to a plurality of transmitting methods. Here, the transmitting methods include an electromagnetic induction method, a resonance method, and a radio wave/microwave radiation method. The first coil 120 is implemented to correspond to a first transmitting method and the second coil 130 is implemented to correspond to a second transmitting method.

For example, either the first transmitting method or the second transmitting method may be implemented in an electromagnetic induction method, and the other may be implemented in a resonance method. Alternatively, both the first transmitting method and the second transmitting method may be implemented in an electromagnetic induction method. However, the first transmitting method and the second transmitting method may have different resonance frequency bands. For example, as illustrated in FIG. 4, the first transmitting method may have a first resonance frequency band fo1 and the second transmitting method may have a second resonance frequency band fo2.

Each of the first coil 120 and the second coil 130 includes an oscillator, a power converter, and at least one transmitting coil. The oscillator generates an AC signal. In this case, the oscillator generates an AC signal corresponding to each transmitting method. Here, the oscillator generates an AC signal to have a predetermined frequency. The power converter converts power and provides the converted power to the transmitting coil. In this case, the power converter receives DC power from the interface 110 and receives the AC signal from the oscillator.

The power converter then generates AC power using the DC power and the AC signal. Here, the power converter may amplify and use the AC signal. Also, the power converter outputs the AC power to the transmitting coil. The power converter may have a push-pull type structure. The push-pull type structure refers to a structure in which pairs of switches, transistors, or arbitrary circuit blocks alternately operate to alternately output a response. The transmitting coil may include either a transmitting induction coil or a transmitting resonance coil according to the transmitting method.

The controller 140 controls overall operations of the wireless power transmitting device 100. In this case, the controller 140 operates the first coil 120 and the second coil 130 to transmit power in a wireless manner. To this end, the controller 140 operates the first coil 120 and the second coil 130 to determine whether the wireless power receiving device 30 (see FIG. 1) exists. Here, the controller 140 may alternately operate the first coil 120 and the second coil 130 to determine whether the wireless power receiving device 30 exists. Accordingly, the controller 140 may detect not only the existence of the wireless power receiving device 30 but also the receiving method of the wireless power receiving device 30. The controller 140 may select either the first coil 120 or the second coil 130 according to the receiving method of the wireless power receiving device 30. Also, when it is determined that the wireless power receiving device 30 exists, the controller 140 operates either the first coil 120 or the second coil 130 to transmit power.

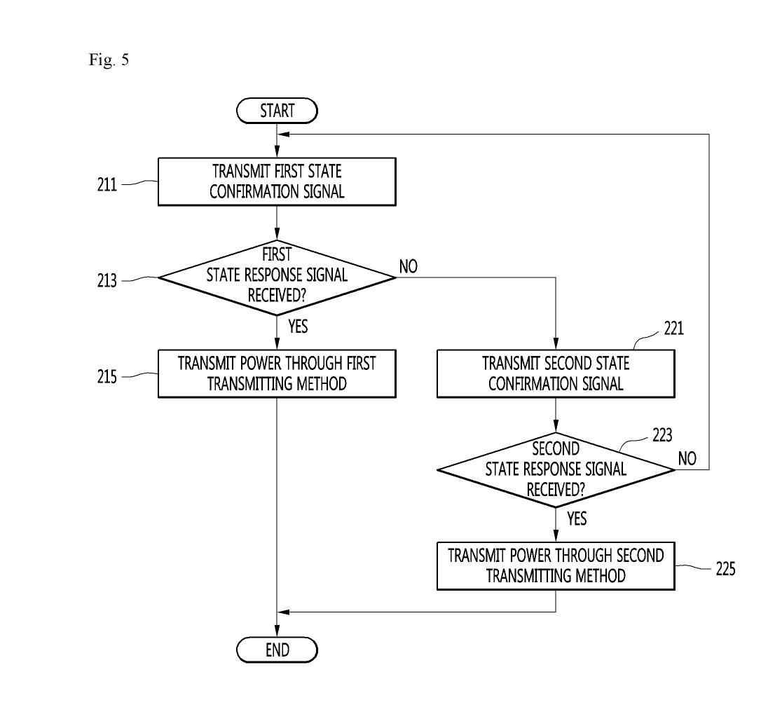

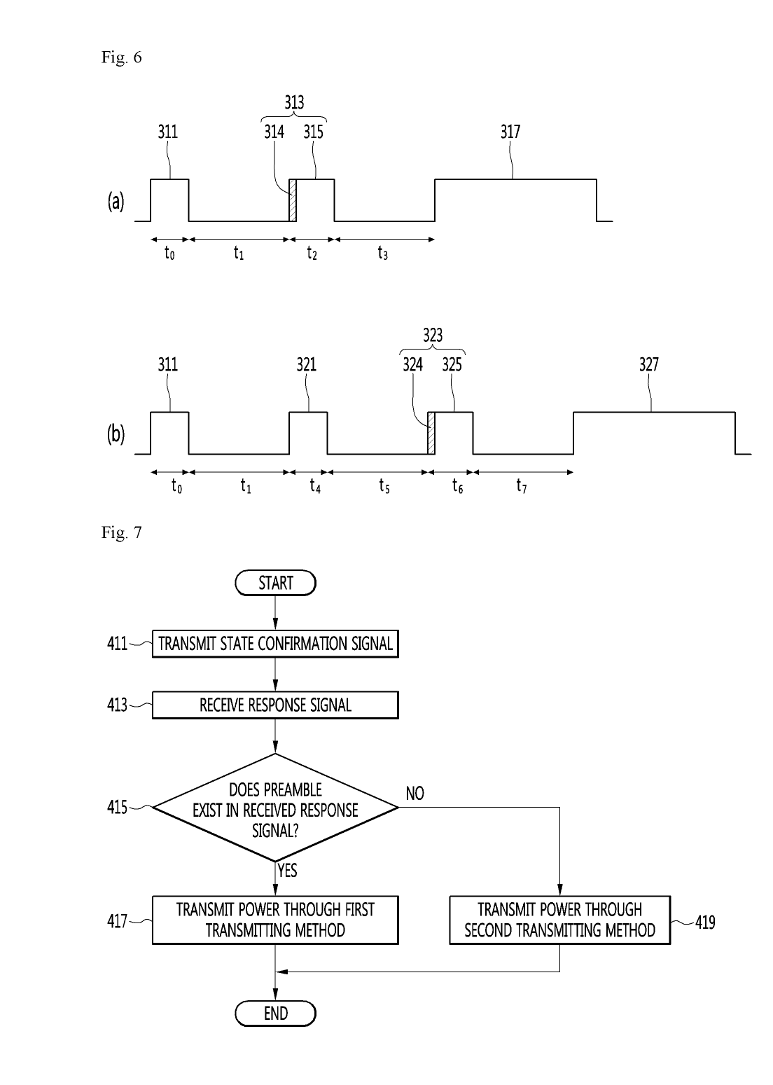

FIG. 5 is a flowchart illustrating a wireless power transmitting process according to an embodiment of the present invention. FIGS. 6A and 6B are diagrams for describing exemplary wireless power transmitting methods according to an embodiment of the present invention. In this case, FIG. 6A illustrates a case in which power is transmitted through a first coil, and FIG. 6B illustrates a case in which power is transmitted through a second coil.

Referring to FIG. 5, the wireless power transmitting process according to the present embodiment starts from the controller 140 transmitting a first state confirmation signal 311 in operation 211. In this case, the controller 140 controls the first coil 120 to transmit the first state confirmation signal 311. That is, the controller 140 generates the first state confirmation signal 311 according to a first transmitting method to transmit the first state confirmation signal 311 through the transmitting coil of the first coil 120. Here, the first state confirmation signal 311 may be a ping signal. For example, as illustrated in FIGS. 6A and 6B, the controller 140 may transmit the first state confirmation signal 311 within a preset time interval t₀. As illustrated in FIGS. 6A and 6B, the controller 140 may then wait for a preset time interval t₁ after transmitting the first state confirmation signal 311.

Next, when a first state response signal 313 corresponding to the first state confirmation signal 311 is received, the controller 140 senses the first state response signal 313 in operation 213. In this case, when the receiving method of the wireless power receiving device 30 (see FIG. 1) corresponds to the first transmitting method, the wireless power receiving device 30 may receive the first state confirmation signal 311. The wireless power receiving device 30 may then transmit the first state response signal 313 in response to the first state confirmation signal 311. Accordingly, the first coil 120 may receive the first state response signal 313. Also, when the first state response signal 313 is received through the first coil 120, the controller 140 may sense the first state response signal 313. For example, as illustrated in FIG. 6A, the wireless power receiving device 30 may transmit the first state response signal 313 within a preset time interval t₂.

In this case, the first state response signal 313 may include a preamble 314 and received information 315. For example, as illustrated in FIG. 6A, the preamble 314 may be transmitted at a front end in the corresponding time interval t₂, and the received information 315 may be continuously transmitted following the preamble 314. Here, the preamble 314 may be made with a binary string. The received information 315 may include identification information and configuration information of the wireless power receiving device 30. For example, the configuration information may include the receiving method of the wireless power receiving device 30. Accordingly, when the wireless power receiving device 30 transmits the first state response signal 313, the controller 140 may preferentially sense the preamble 314 through the first coil 120. Also, as illustrated in FIG. 6A, the controller 140 may wait for a preset time interval t₃ after receiving the first state response signal 313.

Next, the controller 140 transmits power 317 in operation 215 and terminates the wireless power transmitting process. In this case, the controller 140 controls the first coil 120 to transmit the power 317. That is, when the first state response signal 313 in response to the first state confirmation signal 311 is received, the controller 140 detects the existence of the wireless power receiving device 30. Specifically, when the preamble 314 is sensed corresponding to the first state confirmation signal 311, the controller 140 detects the existence of the wireless power receiving device 30. In addition, the controller 140 detects the receiving method of the wireless power receiving device 30. In other words, the controller 140 determines that the receiving method of the wireless power receiving device 30 corresponds to the first transmitting method. Accordingly, the controller 140 converts the power 317 according to the first transmitting method and transmits the power 317 through the first coil 120. For example, as illustrated in FIG. 6A, the controller 140 may transmit the power 317.

Meanwhile, when the first state response signal 313 is not received in operation 213, the controller 140 transmits a second state confirmation signal 321 in operation 221. In this case, the controller 140 controls the second coil 130 to transmit the second state confirmation signal 321. That is, the controller 140 generates the second state confirmation signal 321 according to the second transmitting method to transmit the second state confirmation signal 321 through the transmitting coil of the second coil 130. Here, the second state confirmation signal 321 may be a ping signal. For example, as illustrated in FIG. 6B, the controller 140 may transmit the second state confirmation signal 321 within a preset time interval t₄. As illustrated in FIG. 6B, the controller 140 may then wait for a preset time interval t₅ after transmitting the second state confirmation signal 321.

Next, when a second state response signal 323 corresponding to the second state confirmation signal 321 is received, the controller 140 senses the second state response signal 323 in operation 223. In this case, when the receiving method of the wireless power receiving device 30 corresponds to the second transmitting method, the wireless power receiving device 30 may receive the second state confirmation signal 321. The wireless power receiving device 30 may then transmit the second state response signal 323 in response to the second state confirmation signal 321. Accordingly, the second coil 130 may receive the second state response signal 323. Also, when the second state response signal 323 is received through the second coil 130, the controller 140 may sense the second state response signal 323. For example, as illustrated in FIG. 6B, the wireless power receiving device 30 may transmit the second state response signal 323 within a preset time interval t₆.

In this case, the second state response signal 323 may include a preamble 324 and received information 325. For example, as illustrated in FIG. 6B, the preamble 324 may be transmitted at a front end in the time interval t₆, and the received information 325 may be continuously transmitted following the preamble 324. Here, the preamble 324 may be made with a binary string. The received information 325 may include identification information and configuration information of the wireless power receiving device 30. For example, the configuration information may include the receiving method of the wireless power receiving device 30. Accordingly, when the wireless power receiving device 30 transmits the second state response signal 323, the controller 140 may preferentially sense the preamble 324 through the second coil 130. Also, as illustrated in FIG. 6B, the controller 140 may wait for a preset time interval t₇ after receiving the second state response signal 323.

Next, the controller 140 transmits power 327 in operation 225 and terminates the wireless power transmitting process. In this case, the controller 140 controls the second coil 130 to transmit the power 327. That is, when the second state response signal 323 corresponding to the second state confirmation signal 321 is received, the controller 140 detects the existence of the wireless power receiving device 30. Specifically, when the preamble 324 is sensed corresponding to the second state confirmation signal 321, the controller 140 detects the existence of the wireless power receiving device 30. In addition, the controller 140 detects the receiving method of the wireless power receiving device 30. In other words, the controller 140 determines that the receiving method of the wireless power receiving device 30 corresponds to the second transmitting method. Accordingly, the controller 140 converts the power 327 according to the second transmitting method and transmits the power 327 through the second coil 130. For example, as illustrated in FIG. 6B, the controller 140 may transmit the power 327.

Meanwhile, when the second state response signal 323 is not received in operation 223, the controller 140 returns to operation 211. Then, the controller 140 repeats at least some of operations 211 to 225.

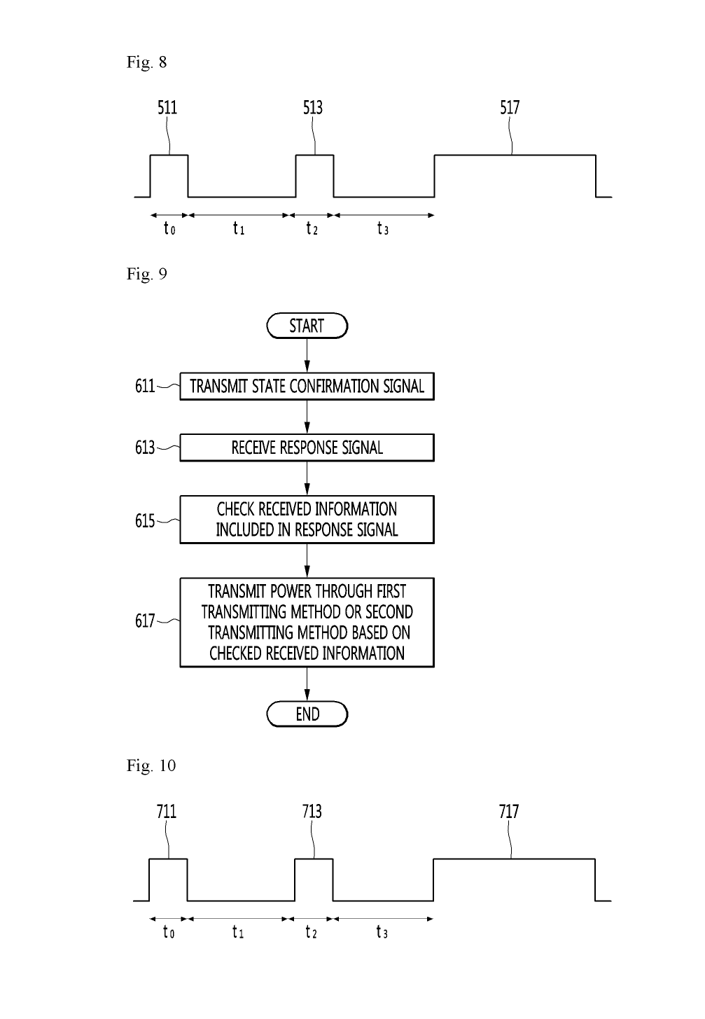

FIG. 7 is a flowchart illustrating a wireless power transmitting process according to another embodiment of the present invention. FIG. 8 is a diagram for describing an exemplary wireless power transmitting method according to another embodiment of the present invention.

Referring to FIG. 7, the wireless power transmitting process according to another embodiment starts from the controller 140 transmitting a status checking signal 511 in operation 411. Here, the status checking signal 511 may be a ping signal. For example, as illustrated in FIG. 8, the controller 140 may transmit the status checking signal 511 within a preset time interval t₀. As illustrated in FIG. 8, the controller 140 may then wait for a preset time interval t₁ after transmitting the status checking signal 511.

Next, a response signal 513 corresponding to the status checking signal 511 may be received. In this case, the controller 140 senses the response signal 513 in operation 413. For example, as illustrated in FIG. 8, the response signal 513 may be received from the wireless power receiving device 30 within a preset time interval t₂.

The controller 140 may check the received response signal 513 and determine whether a preamble is included in the response signal 513 in operation 415. For example, the response signal 513 may include both a preamble and received information or only the received information according to a transmitting method. Here, the preamble may be made with a binary string. The received information may include identification information and configuration information of the wireless power receiving device 30. In this case, the preamble may be transmitted at a front end of the response signal 513 in the receiving interval t₂.

The controller 140 may check the received response signal 513 and determine whether the preamble is included in the response signal in operation 415. When it is determined that the preamble is included in the response signal, the controller 140 may determine that the power receiving method of the wireless power receiving device 30, in which the response signal 513 is transmitted, corresponds to the first transmitting method.

Therefore, the controller 140 waits for a preset time interval t₃ after receiving the response signal 513, controls the first coil 120 to transmit power 517 through the first transmitting method in operation 417, and terminates the wireless power transmitting process.

Meanwhile, in operation 415, when it is determined that the preamble is not included in the received response signal 513, the controller 140 may determine that the power receiving method of the wireless power receiving device 30, in which the response signal 513 is transmitted, corresponds to the second transmitting method.

Therefore, the controller 140 waits for the preset time interval t₃ after receiving the response signal 513, controls the second coil 130 to transmit the power 517 through the second transmitting method in operation 419, and terminates the wireless power transmitting process.

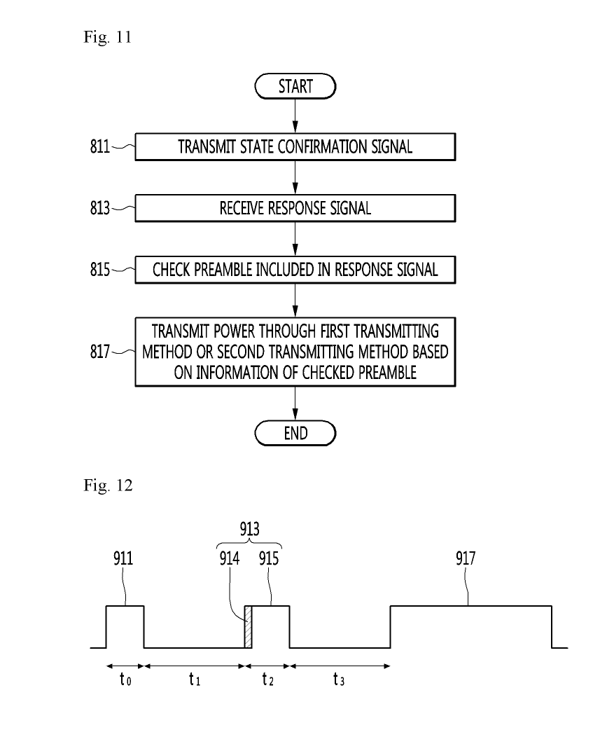

FIG. 9 is a flowchart illustrating a wireless power transmitting process according to still another embodiment of the present invention. FIG. 10 is a diagram for describing an exemplary wireless power transmitting method according to still another embodiment of the present invention.

Referring to FIG. 9, the wireless power transmitting process according to still another embodiment of the present invention starts from the controller 140 transmitting a status checking signal 711 in operation 611. Here, the status checking signal 711 may be a ping signal. For example, as illustrated in FIG. 10, the controller 140 may transmit the status checking signal 711 within a preset time interval t₀. As illustrated in FIG. 10, the controller 140 may then wait for a preset time interval t₁ after transmitting the status checking signal 711.

Next, a response signal 713 corresponding to the status checking signal 711 may be received. In this case, the controller 140 senses the response signal 713 in operation 613. For example, as illustrated in FIG. 10, the response signal 713 may be received from the wireless power receiving device 30 within a preset time interval t₂.

The controller 140 may check the received response signal 713 in operation 615. For example, the response signal 713 may include received information. The received information may include identification information and configuration information of the wireless power receiving device 30. For example, the configuration information may include a power receiving method of the wireless power receiving device 30.

In operation 617, the controller 140 may transmit power to the wireless power receiving device 30 in a power transmitting method corresponding to the power receiving method of the wireless power receiving device 30 based on the received information checked in operation 615.

Specifically, when it is determined that the power receiving method of the wireless power receiving device 30 corresponds to a first transmitting method based on the received information checked in operation 615, the controller 140 waits for a preset time interval t₃ after receiving the response signal 713, controls the first coil 120 to transmit power 717 through the first transmitting method in operation 617, and terminates the wireless power transmitting process.

On the other hand, when it is determined that the power receiving method of the wireless power receiving device 30 corresponds to a second transmitting method based on the received information checked in operation 615, the controller 140 waits for the preset time interval t₃ after receiving the response signal 713, controls the second coil 130 to transmit the power 717 through the second transmitting method in operation 617, and terminates the wireless power transmitting process.

Meanwhile, when the power receiving method of the wireless power receiving device 30 is not checked through the checked received information of the response signal 713, the controller 140 returns to operation 611. Then, the controller 140 repeats at least some of operations 611 to 617.

FIG. 11 is a flowchart illustrating a wireless power transmitting process according to yet another embodiment of the present invention. FIG. 12 is a diagram for describing an exemplary wireless power transmitting method according to yet another embodiment of the present invention.

Referring to FIG. 11, the wireless power transmitting process according to yet another embodiment of the present invention starts from the controller 140 transmitting a status checking signal 911 in operation 811. Here, the status checking signal 911 may be a ping signal. For example, as illustrated in FIG. 12, the controller 140 may transmit the status checking signal 911 within a preset time interval t₀. As illustrated in FIG. 12, the controller 140 may then wait for a preset time interval t₁ after transmitting the status checking signal 911.

Next, a response signal 913 corresponding to the status checking signal 911 may be received. In this case, the controller 140 senses the response signal 913 in operation 813. For example, as illustrated in FIG. 12, the response signal 913 may be received from the wireless power receiving device 30 within a preset time interval t₂.

In this case, the response signal 913 may include a preamble 914 and received information 915. For example, as illustrated in FIG. 12, the preamble 914 may be transmitted at a front end in the corresponding time interval t₂, and the received information 915 may be continuously transmitted following the preamble 914. Also, the preamble 914 may include a power receiving method of the wireless power receiving device 30. Therefore, when the response signal 913 is received in operation 813, the controller 140 may check the preamble 914 which is included in the received response signal 913 in operation 815.

The controller 140 may check the preamble 914 of the response signal 913, which is checked in operation 815, to transmit power to the wireless power receiving device 30 in a power transmitting method corresponding to the power receiving method of the wireless power receiving device 30 in operation 817.

Specifically, when it is checked that the power receiving method of the wireless power receiving device 30 corresponds to a first transmitting method based on information included in the preamble 914 in operation 815, the controller 140 waits for a preset time interval t₃ after receiving the response signal 913, controls the first coil 120 to transmit power 917 through the first transmitting method in operation 817, and terminates the wireless power transmitting process.

On the other hand, when it is checked that the power receiving method of the wireless power receiving device 30 corresponds to a second transmitting method based on the information included in the preamble 914 in operation 815, the controller 140 waits for the preset time interval t₃ after receiving the response signal 913, controls the second coil 130 to transmit the power 917 through the second transmitting method in operation 817, and terminates the wireless power transmitting process.

Meanwhile, when the power receiving method of the wireless power receiving device 30 is not checked through the checked response signal 913, the controller 140 returns to operation 811. Then, the controller 140 repeats at least some of operations 811 to 817.

According to the present invention, the wireless power transmitting device 100 may detect the existence of the wireless power receiving device 30 (see FIG. 1) and the receiving method thereof by alternately using the first transmitting method and the second transmitting method. Thus, the wireless power transmitting device 100 may effectively charge the wireless power receiving device 30 using the first transmitting method and the second transmitting method. That is, the wireless power transmitting device 100 may transmit power according to a plurality of transmitting methods. Accordingly, the wireless power transmitting device 100 may efficiently transmit power according to the receiving method of the wireless power receiving device 30.

In the embodiments of the present invention, the controller 140 has been described as checking the response signal received from the wireless power receiving device 30, waiting for the preset time interval t₃, and transmitting the power according to the checked power transmitting method. However, the present invention is not limited thereto, and the controller 140 may check the response signal and transmit the power in the checked power transmitting method consecutively after receiving the response signal without waiting for the preset time interval t₃.

That is, the power transmission starts consecutively after receiving the response signal, and the identification information and configuration information of the wireless power receiving device 30 may be checked when the power transmission starts.

Meanwhile, the embodiments disclosed in this specification and drawings are only examples to facilitate an understanding of the invention, and the invention is not limited thereto. That is, it should be apparent to those skilled in the art that various modifications can be made on the basis of the technological scope of the invention in addition to the embodiments disclosed herein.

1-14. (canceled)

15. A wireless power transmitting method comprising:
transmitting a state confirmation signal from one of a first transmitting coil which transmits power through a first transmitting method and a second transmitting coil which transmits power through a second transmitting method to a wireless power receiving device;
receiving a response signal corresponding to the transmitted confirmation signal;
transmitting the power to the wireless power receiving device through one of the first transmitting method and the second transmitting method based on the received response signal.

16. The wireless power transmitting method of claim 15, wherein the state confirmation signal is a ping signal.

17. The wireless power transmitting method of claim 15, wherein the power is transmitted through a power transmitting method corresponding to one of the first transmitting coil and the second transmitting coil which receives the response signal corresponding to the state confirmation signal.

18. The wireless power transmitting method of claim 17, wherein the response signal includes a preamble and received information which follows the preamble.

19. The wireless power transmitting method of claim 15, wherein the first transmitting coil and the second transmitting coil sequentially transmit the state confirmation signal to the wireless power receiving device.

20. The wireless power transmitting method of claim 19, wherein one of the first transmitting coil and the second transmitting coil first transmits the state confirmation signal, and then the other one transmits the state confirmation signal after a critical waiting time.

21. The wireless power transmitting method of claim 15, wherein the response signal through the first transmitting method includes a preamble and received information, and the response signal through the second transmitting method includes received information, and the transmitting of the power is performed through a power transmitting method in which whether the preamble exists is confirmed when the response signal is received.

22. The wireless power transmitting method of claim 15, wherein the response signal includes charging method information of the wireless power receiving device, and the transmitting of the power is performed based on the charging method information.

23. The wireless power transmitting method of claim 22, wherein the charging method information is included in an identifier field of the received response signal.

24. The wireless power transmitting method of claim 15, wherein the response signal includes a preamble and received information which follows the preamble, and the transmitting of the power is performed based on charging method information included in the preamble.

25. A wireless power transmitting device comprising:
a first coil configured to transmit power through a first transmitting method;
a second coil configured to transmit the power through a second transmitting method; and
a controller configured to transmit a state confirmation signal from one of the first coil and the second coil to a wireless power receiving device, receive a response signal corresponding to the transmitted state confirmation signal, and transmit power to the wireless power receiving device through one of the first transmitting method and the second transmitting method based on the received response signal.

26. The wireless power transmitting device of claim 25, wherein the state confirmation signal is a ping signal.

27. The wireless power transmitting device of claim 25, wherein the controller controls so that the power is transmitted through a power transmitting method corresponding to one of the first transmitting coil and the second transmitting coil which receives the response signal corresponding to the transmitted state confirmation signal.

28. The wireless power transmitting device of claim 27, wherein the response signal includes a preamble and received information which follows the preamble.

29. The wireless power transmitting device of claim 25, wherein the controller controls so that the first transmitting coil and the second transmitting coil sequentially transmit the state confirmation signal to the wireless power receiving device.

30. The wireless power transmitting device of claim 29, wherein the controller controls so that one of the first transmitting coil and the second transmitting coil first transmits the state confirmation signal, and then the other one transmits the state confirmation signal after a critical waiting time.

31. The wireless power transmitting device of claim 25, wherein the response signal through the first transmitting method includes a preamble and received information, and the response signal through the second transmitting method includes received information, and the controller controls so that the transmitting of the power is performed through a power transmitting method in which whether the preamble exists is confirmed when the response signal is received.

32. The wireless power transmitting device of claim 25, wherein the response signal includes charging method information of the wireless power receiving device, and the controller performs the transmitting of the power based on the charging method information.

33. The wireless power transmitting device of claim 32, wherein the charging method information is included in an identifier field of the received response signal.

34. The wireless power transmitting device of claim 25, wherein the response signal includes a preamble and received information which follows the preamble, and the controller performs the transmitting of the power based on charging method information included in the preamble.
